(19) United States
(12) Patent Application Publication
(10) Pub. No.: US 2021/0031797 A1
(43) Pub. Date: Feb. 4, 2021

(54) VEHICLE RUNNING CONTROL DEVICE AND VEHICLE RUNNING CONTROL METHOD

(71) Applicant: TOYOTA JIDOSHA KABUSHIKI KAISHA, Toyota-shi (JP)

(72) Inventors: Miyako HAYASHIDA, Miyoshi-shi (JP); Toshinari OGAWA, Nagoya-shi (JP); Kosuke FUJIMOTO, Nisshin-shi (JP); Hideo HASEGAWA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 16/927,152

(22) Filed: Jul. 13, 2020

(30) Foreign Application Priority Data
Jul. 30, 2019 (JP) 2019-140115

(51) Int. Cl. B60W 60/00; G01C 21/34; G01C 21/00

(52) U.S. Cl. CPC B60W 60/005; B60W 60/0025; G01C 21/3461; G01C 21/3841; G01C 21/3407

(57) ABSTRACT

A vehicle running control device that acquires a running path of a vehicle to a destination and path information relating to autonomous driving of the vehicle on the running path; that, on the basis of the path information relating to autonomous driving, predicts a remote driving segment of the running path in which running control of the vehicle in a remote driving mode is required; that, before the vehicle reaches the predicted remote driving segment, makes a request to a remote operation equipment for entry of operation information relating to remote driving; and that, when running is being controlled in an autonomous driving mode and the operation information relating to remote driving is entered through the remote operation equipment, switch to operate in the remote driving mode.

### CROSS-REFERENCE TO RELATED APPLICATION

This application is based on and claims priority under 35 USC 119 from Japanese Patent Application No. 2019-140115 filed on Jul. 30, 2019, the disclosure of which is incorporated by reference herein.

### TECHNICAL FIELD

The present disclosure relates to a vehicle running control device and a vehicle running control method.

### RELATED ART

Driving assistance devices that assist driving operations by drivers have been proposed for automobiles. Driving assistance devices that have been proposed include a driving assistance device that features automatic driving functions which conduct steering, speed control and so forth in place of a driver, and a driving assistance device that, in addition to automatic driving functions, includes remote operation functions that enable running control, such as steering control, speed control and the like of the vehicle, through remote operations by remote operation staff.

For example, in the driving assistance device of International Publication No. WO2016/038931, peripheral environment information of a vehicle is acquired and autonomous automatic driving is executed on the basis of the acquired peripheral environment information. In this driving assistance device, a determination is made as to whether to execute autonomous automatic driving on the basis of the peripheral environment information. When a determination is made not to execute autonomous automatic driving, heteronomous automatic driving by remote control or convoy running (following running) by automatic driving is executed.

Some vehicles are towing vehicles (tractors) that are capable of towing various kinds of trailers (trailing vehicles) such as food trucks, mobile homes and so forth. A trailer or the like is moved by being towed by a towing vehicle, is towed into an area in which entry by ordinary vehicles is not permitted, such as a public park or other large site, and is used therein. After use, the trailer or the like is towed out by the towing vehicle. Within a site into which this trailer or the like is driven, vehicle running by autonomous automatic driving (in a self-driving mode) is troublesome.

When a determination is made, on the basis of peripheral environment information of a running vehicle, to switch from an autonomous automatic driving mode, which is not dependent on operations by a vehicle occupant, to a heteronomous automatic driving mode, which depends on remote operation by remote operation staff rather than operation by a vehicle occupant, the remote operation staff may experience a sudden request for remote operation. To enable smoother vehicle running in response to requests for remote operation, the remote operation staff may be continuously on standby so as to be ready for remote operation. There is concern that this puts a large burden on the remote operation staff, and there are calls for improvement.

### SUMMARY

An aspect of the disclosure is a vehicle running control device that includes: a running control section that is capable of controlling running of a vehicle in an autonomous driving mode and in a remote driving mode and that controls running of the vehicle toward a destination, the autonomous driving mode controlling running of the vehicle on the basis of operation information relating to autonomous driving of the vehicle that is obtained from a running environment surrounding the vehicle, and the remote driving mode being based on operation information relating to remote driving of the vehicle that is entered through remote operation equipment operated by remote operation staff; a path information acquisition section that acquires a running path of the vehicle to the destination and path information relating to autonomous driving of the vehicle on the running path; a prediction section that, on the basis of the path information relating to autonomous driving, predicts a remote driving segment of the running path in which running control of the vehicle in the remote driving mode is required; a request section that, before the vehicle reaches the predicted remote driving segment, makes a request to the remote operation equipment for entry of the operation information relating to remote driving; and a switching section that, when the running control section is operating in the autonomous driving mode and the operation information relating to remote driving is entered through the remote operation equipment, switches the running control section to operate in the remote driving mode.

### BRIEF DESCRIPTION OF DRAWINGS

FIG. 1 is a schematic structural diagram of a vehicle control system according to a present exemplary embodiment.

FIG. 2 is a block diagram showing schematic structures of a running control device.

FIG. 3 is a flowchart showing navigation processing for specifying a running path and remote driving segments.

FIG. 4 is a schematic diagram showing an example of a running path.

FIG. 5 is a flowchart showing driving mode switching processing in an autonomous driving mode.

FIG. 6 is a hardware structure diagram of an ECU according to the present exemplary embodiment.

### DETAILED DESCRIPTION

Herebelow, an exemplary embodiment of the present disclosure is described in detail with reference to the attached drawings.

In the present exemplary embodiment, an automobile that runs using a drive source such as an engine, an electric motor or the like (below referred to as the vehicle 10) is deployed as a vehicle. The vehicle 10 is capable of running in driving modes (below referred to as automatic driving modes) that are not dependent on driving operation by a vehicle occupant (a driver). The automatic driving modes that are not dependent on driving operation by a vehicle occupant include an autonomous driving mode, which conducts autonomous running of the vehicle 10, and a remote driving mode (a heteronomous driving mode), which conducts heteronomous running of the vehicle 10 in accordance with remote operation by remote operation staff.

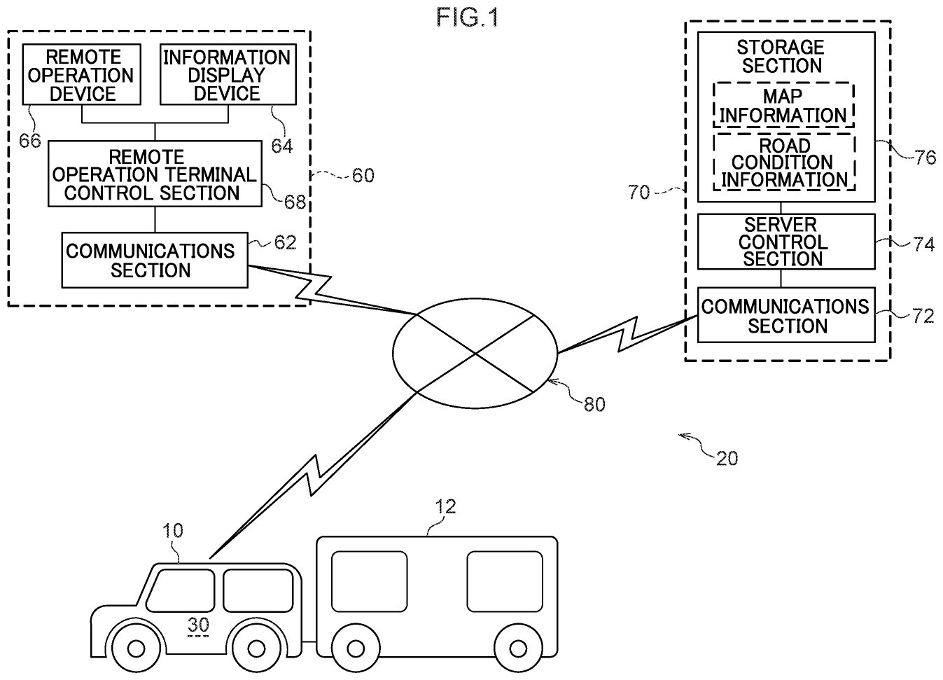

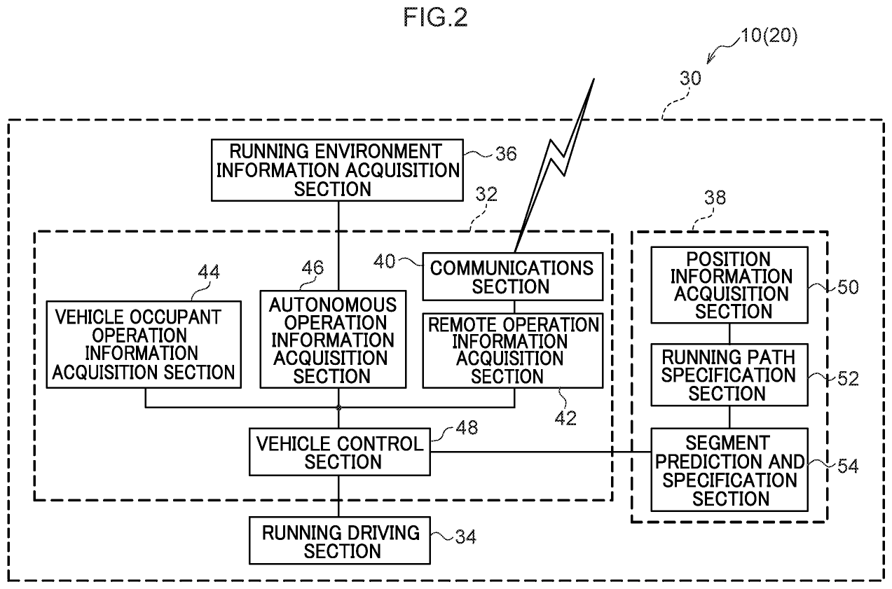

In the present exemplary embodiment, a vehicle control system 20 is employed as a vehicle running control system. The vehicle control system 20 controls running of the vehicle 10 in the automatic driving modes. The vehicle control system 20 is capable of switching the automatic driving modes between the autonomous driving mode and the remote driving mode. FIG. 1 shows schematic structures of the vehicle control system 20 in a block diagram, and FIG. 2 shows principal portions thereof that are in the vehicle 10 in a block diagram.

As shown in FIG. 1, the vehicle control system 20 is provided with a running control device 30, a remote operation terminal 60 and a server 70. The running control device 30 is provided in the vehicle 10 and serves as a vehicle running control device. The remote operation terminal 60 serves as remote operation equipment. The server 70 constitutes a storage section. The running control device 30, remote operation terminal 60 and server 70 of the vehicle 10 are connected by predetermined communication systems 80.

An arbitrary kind of vehicle may be employed as the vehicle 10. However, in the present exemplary embodiment, the vehicle 10 is a vehicle that is capable of running while trailing a trailing vehicle. The vehicle 10 is structured as a vehicle (a tractor) that is capable of towing a trailing vehicle. The vehicle 10 is capable of running while towing one or a plural number of a trailer 12, which is linked by a towing apparatus and serves as a trailing vehicle (a towed vehicle).

As shown in FIG. 2, the running control device 30 is provided with an electronic control unit (ECU) 32 that controls vehicle running, a running driving section 34 that causes running of the vehicle to be driven in accordance with control signals from the ECU 32, a running environment information acquisition section 36 that acquires running environment information of the vehicle 10, and a navigation section (navigation device) 38.

The ECU 32 is provided with a communications section 40, a remote operation information acquisition section 42, a vehicle occupant operation information acquisition section 44, an autonomous operation information acquisition section 46, and a vehicle control section 48 that corresponds to a running control section.

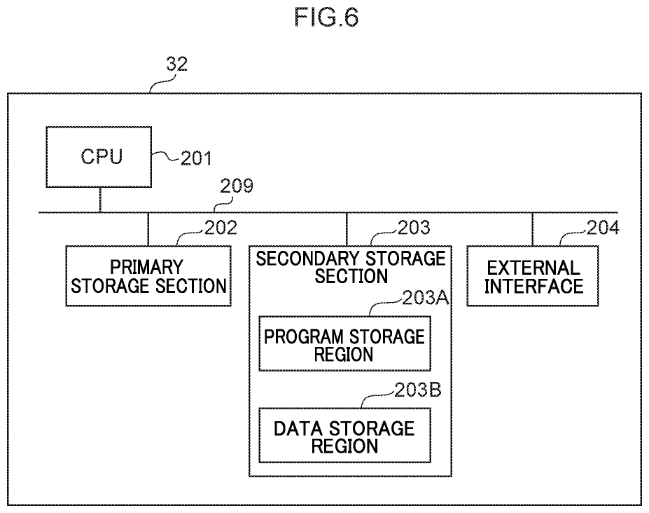

As shown in FIG. 6, the ECU 32 includes, for example, a central processing unit (CPU) 201, a primary storage section 202, a secondary storage section 203 and an external interface 204. The CPU 201 is an example of a hardware processor. The CPU 201, the primary storage section 202, the secondary storage section 203 and the external interface 204 are connected with one another via a bus 209. A graphics processing unit (GPU) may be employed instead of a CPU.

The primary storage section 202 is a volatile memory such as, for example, a random access memory (RAM) or the like. The secondary storage section 203 is a nonvolatile memory such as, for example, a hard disk drive (HDD), a solid state drive (SSD) or the like.

The secondary storage section 203 includes a program storage region 203A and a data storage region 203B. The program storage region 203A stores programs such, as for example, a vehicle running control program that conducts vehicle running control processing, and the like. The data storage region 203B stores, for example, intermediate data generated during execution of the vehicle running control program and the like.

The CPU 201 reads the vehicle running control program from the program storage region 203A and loads the vehicle running control program into the primary storage section 202. By loading and executing the vehicle running control program, the CPU 201 operates as the communications section 40, the remote operation information acquisition section 42, the vehicle occupant operation information acquisition section 44, the autonomous operation information acquisition section 46 and the vehicle control section 48.

Programs such as the vehicle running control program and the like may be stored at an external server and loaded into the primary storage section 202 via a network. Further, programs such as the vehicle running control program and the like may be stored in a non-transient recording medium such as a digital versatile disc (DVD) or the like and loaded into the primary storage section 202 via a recording medium reading/writing apparatus.

External equipment is connected to the external interface 204. The external interface 204 administers transmission and reception of various kinds of information between external equipment and the CPU 201. For example, as illustrated in FIG. 2, the running driving section 34, the running environment information acquisition section 36 and the navigation section 38 may be connected to the external interface 204.

The communications section 40 communicates with other equipment (the remote operation terminal 60, the server 70 and so forth) and transmits and receives various kinds of information via the communication systems 80.

The remote operation information acquisition section 42 acquires remote operation information that is transmitted from the remote operation terminal 60 via the server 70 and received by the communications section 40. The remote operation information transmitted from the remote operation terminal 60 is operation information relating to remote driving, which is entered at the remote operation terminal 60 by remote operation staff. The remote operation information includes steering information, speed information, braking information and the like for remotely operating the vehicle 10.

The vehicle occupant operation information acquisition section 44 acquires manual operation information that serves as operation information relating to manual driving, which is entered by a vehicle occupant of the vehicle 10. The manual operation information includes steering information that is entered by operation of a steering wheel (steering) by the vehicle occupant, speed operations that are entered by operation of an accelerator pedal by the vehicle occupant, braking operations that are entered by operation of a brake pedal or the like by the vehicle occupant, and so forth.

The running driving section 34 is controlled on the basis of the manual operation information acquired by the vehicle occupant operation information acquisition section 44. Thus, running of the vehicle 10 can be controlled in accordance with driving operations by the vehicle occupant (running control in a manual driving mode).

The running environment information acquisition section 36 acquires running environment information that is used as information for executing autonomous running of the vehicle 10. The running environment information acquired by the running environment information acquisition section 36 may include information such as sensor signals obtained by various sensors mounted at the vehicle 10, information corresponding to sensor signals, and the like.

More specifically, the running environment information includes images (image information) of the surroundings of the vehicle 10, including a progress direction thereof, objects such as vehicles, people and the like in the surroundings of the vehicle 10, and distances, relative movement directions, relative speeds and the like of the objects. The images are acquired using image sensors and the like, and the information of the objects is acquired using laser sensors and the like. The running environment information may also include sounds of the surroundings of the vehicle 10, and the running environment information may include control information acquired from ECUs other than the ECU 32.

The autonomous operation information acquisition section 46 acquires information relating to autonomous running of the vehicle 10 from the running environment information acquired by the running environment information acquisition section 36. From the acquired information relating to autonomous operation, the autonomous operation information acquisition section 46 acquires autonomous operation information to be used as operation information relating to autonomous operation of the vehicle 10. The autonomous operation information includes steering information, speed information, braking information and the like for autonomous running of the vehicle 10.

The vehicle control section 48 controls the running driving section 34 on the basis of the remote operation information acquired by the remote operation information acquisition section 42, the vehicle occupant operation information acquired by the vehicle occupant operation information acquisition section 44, and the autonomous operation information acquired by the autonomous operation information acquisition section 46. On the basis of the remote operation information, the manual operation information and the autonomous operation information, the vehicle control section 48 also implements switching of the driving mode between the manual driving mode and the automatic driving modes, and when switched to the automatic driving modes, implements switching between the autonomous driving mode that conducts running control in accordance with the autonomous operation information and the remote driving mode that conducts running control in accordance with the remote operation information.

As shown in FIG. 1, the server 70 is provided with a communications section 72, a server control section 74 and a storage section 76. The communications section 72 communicates with the running control device 30 and the remote operation terminal 60 and transmits and receives information via the communication systems 80. The server control section 74 controls the communications section 72 and controls transmission and reception of information.

Various kinds of information are stored in the storage section 76, such as map information, autonomous road condition information (road information) that serves as path information relating to autonomous driving, and so forth. The road condition information stored in the storage section 76 includes, with map information, path information such as road conditions relating to running of the vehicle 10 in the autonomous driving mode (autonomous running) and so forth.

The road condition information includes whether or not road conditions allow running positions of the vehicle 10 on a road to be clearly identified from running environment information acquired by the vehicle 10, which depends on the provision of road infrastructure and the like. The road condition information also includes whether or not the provision of road infrastructure can be considered adequate, and whether or not there are areas other than roads in which running based on autonomous driving of the vehicle 10 may occur, such as within sites such as public parks, facilities and the like. Still further, the road condition information includes information on whether or not road conditions may affect the autonomous running of the vehicle 10. Information that may affect the autonomous running includes, for example, running information of emergency vehicles and the like.

In general, an emergency vehicle or the like runs toward a destination. For example, an ambulance runs toward a destination that is the location of a transport subject such as a sick or injured person or the like, or that is an emergency hospital to which a transport subject is being transported, or the like. In a region (which may be an intersection) in which the running path of an emergency vehicle or the like overlaps with the running path of the vehicle 10, there is a possibility that running of the emergency vehicle may affect running of the vehicle 10 in the autonomous driving mode or that the vehicle running in the autonomous driving mode may affect running of the emergency vehicle. Therefore, it is preferable that the road condition information includes running information of an emergency vehicle or the like, such as a running path (a predicted running path), running timings on the path (predicted timings) and the like.

The server control section 74 controls transmission and reception of information such as map information and road condition information. Thus, the server control section 74 continuously updates the map information and road condition information stored in the storage section 76. Therefore, changes in road conditions of roads and the most recent running information of emergency vehicles and the like can be reflected in the road condition information stored in the storage section 76.

The remote operation terminal 60 is provided with a communications section 62, an information display device 64 at which a display screen device and the like are employed, a remote operation device 66, and a remote operation terminal control section 68. The communications section 62 conducts communications with the running control device 30 of the vehicle 10 and the server 70 via the communication systems 80, transmitting and receiving various kinds of information. The remote operation terminal control section 68 controls the communications section 62, thus controlling transmission and reception of information, and controls operations of the information display device 64 and the remote operation device 66.

Operation information relating to remote operation of the vehicle 10 is entered at the remote operation device 66 by the remote operation staff. For example, steering information for steering the vehicle 10, speed information for controlling the speed of the vehicle 10, braking information for braking the vehicle 10, and the like are entered at the remote operation device 66.

The remote operation terminal control section 68 transmits operation information entered at the remote operation device 66 by the remote operation staff to the running control device 30 of the vehicle 10 to be used as remote operation information. Accordingly, the vehicle control section 48 of the running control device 30 may control running of the vehicle 10 in the remote driving mode.

The remote operation terminal control section 68 displays information based on the running environment information acquired at the vehicle 10 (for example, images of the surroundings of the vehicle 10 and the like) at the information display device 64. In addition, if sounds of the surroundings of the vehicle 10 are included in the running environment information, the remote operation terminal control section 68 uses sound equipment to convey the sounds of the surroundings of the vehicle 10 to the remote operation staff. Thus, the remote operation staff may enter remote operation information with the feeling of conducting driving operations in a driving seat of the vehicle 10.

As shown in FIG. 2, the navigation section 38 is provided with a position information acquisition section 50, a running path specification section 52, and a segment prediction and specification section 54. The navigation section 38 functions as a prediction section. The position information acquisition section 50 acquires the position of the present vehicle (the vehicle 10) using a positioning system such as, for example, GPS (Global Positioning System) or the like. The navigation section 38 includes a function to clearly show the position of the vehicle 10 to the vehicle occupant and the like by displaying the position of the vehicle 10 acquired by the position information acquisition section 50 on a map, or the like.

When a destination of the vehicle 10 (or a destination position at the destination) is entered, the running path specification section 52 uses map information to specify running path information representing a running path of the vehicle 10 to the destination. The navigation section 38 may guide the vehicle 10 to the destination (destination position) on the basis of the running path information. In the present exemplary embodiment, as an example, a particular position at a destination is used as a destination position. For example, when the destination is a public park or the like, a particular position within the park is used as the destination position.

The segment prediction and specification section 54 acquires road condition information to be used as path information for the running path designated by the running path information. On the basis of the running path information and the road condition information, the segment prediction and specification section 54 designates segments in which it is predicted that it will be more preferable to control running in the remote driving mode than to control running in the autonomous driving mode, and segments in which it is predicted that running control in the autonomous driving mode will be difficult. The segment prediction and specification section 54 specifies the segments of the running path for which these predictions are made as remote driving segments, and may identify segments that are not remote driving segments as autonomous driving segments.

For example, when a running path to a destination position includes a segment that is not road—such as within a site or in a predetermined area such as a public park, farmland, pasture, a wilderness area or the like—or a segment that is road but in which infrastructure provision cannot be considered adequate, a segment in which the road is being repaired, a segment with traffic restrictions, or the like, the segment prediction and specification section 54 specifies this segment as a remote driving segment. Further, when a running path overlaps with a running path of an emergency vehicle or the like and a timing at which the vehicle 10 is predicted to pass along the running path overlaps with a timing at which the emergency vehicle or the like is predicted to pass, the segment prediction and specification section 54 specifies that segment as a remote driving segment. These remote driving segments are segments in which it is predicted that running in the autonomous driving mode will be difficult and segments in which it is predicted that running in the remote driving mode will be more preferable than the autonomous driving mode.

The segment prediction and specification section 54 also acquires the most recent road condition information and running environment information and updates the remote driving segments on the basis of the acquired road condition information and running environment information, so as to appropriately respond to changes in running of the vehicle 10 and road conditions.

The vehicle control section 48 controls running of the vehicle 10 in the autonomous driving mode, and controls running of the vehicle 10 in the automatic driving modes so as to switch to the remote driving mode in the remote driving segments. The vehicle control section 48 also functions as a request section and a switching section. The vehicle control section 48 makes requests to the remote operation terminal 60 in accordance with the running of the vehicle 10, for entry of remote operation information and for halting entry. The vehicle control section 48 switches between the autonomous driving mode and the remote driving mode in response to entries and halts of remote operation information from the remote operation terminal 60.

Now, running control of the vehicle 10 by the vehicle control system 20 is described.

The running control device 30 of the vehicle control system 20 switches between the manual driving mode and the automatic driving modes, and when switched to the automatic driving modes, switches between the autonomous driving mode and the remote driving mode.

In the autonomous driving mode, the running control device 30 controls the running driving section 34 in accordance with the autonomous operation information acquired by the autonomous operation information acquisition section 46 from the running environment information acquired by the running environment information acquisition section 36. For example, the running control device 30 identifies a running lane from images (video images) of the progress direction side of the vehicle 10 that are obtained from the running environment information, and steers the vehicle 10 so as to run along the identified running lane. The running control device 30 also conducts speed control and braking control such that speeds (vehicle speeds) of the vehicle 10 acquired by a vehicle speed sensor and the like are at a predetermined speed.

At the remote operation terminal 60, the remote operation staff enters information relating to running of the vehicle 10 at the remote operation device 66 while viewing images corresponding to the running environment information of the vehicle 10, which are displayed at the information display device 64, and suchlike. The remote operation terminal control section 68 acquires remote operation information from the information entered at the remote operation device 66 and transmits the acquired remote operation information to the vehicle 10 (to the running control device 30).

In the remote driving mode, the running control device 30 controls the running driving section 34 on the basis of the remote operation information acquired by the remote operation information acquisition section 42. Thus, in the remote driving mode, running of the vehicle 10 is controlled in accordance with operations entered by the remote operation staff (remote operations). When the running control device 30 is set to the manual driving mode, the running driving section 34 is controlled on the basis of manual operations acquired by the vehicle occupant operation information acquisition section 44 in accordance with driving operations by a vehicle occupant.

Now, running control of the vehicle 10 in the automatic driving modes is described.

The vehicle 10 may run while towing the trailer 12. For example, the vehicle 10 transports the trailer 12 to a destination position at a destination to deliver the trailer 12 to a user (a trailing end position, which is a towing end position). Alternatively, the vehicle 10 runs to a destination position at a destination to collect the trailer 12 from a user (a trailing start position, which is a towing start position), is linked to the trailer 12 at this destination position, and runs to a succeeding destination position or the like. Destination positions can include a home position of the vehicle 10 and the like.

The trailer 12 that is employed may be, for example, a mobile home, a stall, a food truck in which food preparation equipment is installed and food preparation at a destination position is possible, a rental vehicle that is one of various portable buildings that can be used as meeting spaces and the like, or the like. The trailer 12 is not limited thus; trailing vehicles with various functions may be employed.

A request is made to the vehicle 10 to transport the trailer 12 to a particular position (a destination position) in a site such as a public park or the like away from roads on which autonomous running is possible.

The vehicle control system 20 specifies a position in the destination site at which the trailer 12 is to be delivered to a user or a position at which the trailer 12 is to be collected from a user as the destination position, and the vehicle control system 20 causes the vehicle 10 to run toward the destination position.

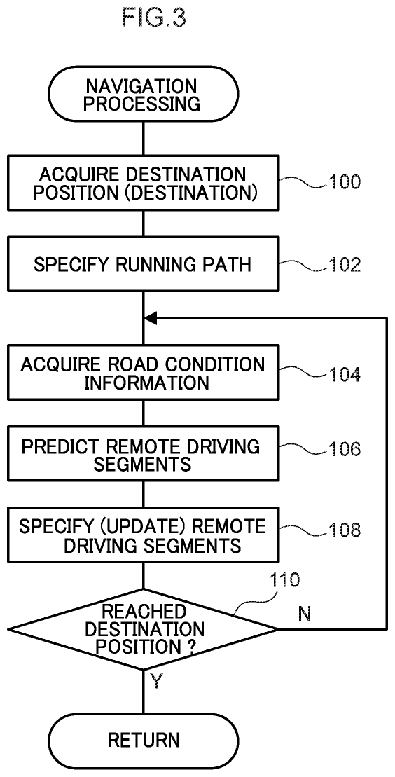

FIG. 3 shows an outline of processing that is executed by the navigation section 38 (navigation processing) at the running control device 30 of the vehicle control system 20. In the running control device 30, the navigation section 38 continuously acquires present vehicle positions (positions of the vehicle 10).

The processing in FIG. 3 starts execution, for example, when the vehicle 10 starts running (possibly before the vehicle 10 starts running) and ends execution when the vehicle 10 stops running or the like. In the first step 100 of this flowchart, a destination position is acquired. The destination position may be acquired by being entered at an operation panel connected to the navigation section 38. If the vehicle control system 20 is connected to a management system that manages the trailer 12, the destination position may be acquired from a server of the management system of the trailer 12 or the like.

In step 102, a running path of the vehicle 10 is specified. For the specification of the running path, map information is acquired, and the running path is specified on the basis of time, distance and the like required for the vehicle 10 to reach the destination position in the acquired map information.

In step 104, road condition information for the specified running path is acquired. In step 106, remote driving segments are predicted from the running path and the road condition information. In order to reduce burdens on remote operation staff, the running control device 30 gives priority to running control in the autonomous driving mode. In this step, the running control device 30 predicts segments of the running path in which it is predicted that running control in the remote driving mode will be more preferable than the autonomous driving mode and segments in which it is predicted that appropriate running control in the autonomous running mode will be difficult (for example, segments in which stoppages of the vehicle 10 in the autonomous running mode are predicted), and the running control device 30 specifies the predicted segments as remote driving segments.

In step 108, on the basis of the prediction results, the running path is specified to be divided into remote driving segments and autonomous driving segments that are not the remote driving segments. Hence, the running control device 30 may control running of the vehicle 10 toward the destination position in the automatic driving modes. In step 110, the running control device 30 verifies whether or not the vehicle 10 has reached the destination position. When the vehicle 10 reaches the destination position, the result of the determination in step 110 is affirmative and the processing ends.

While the vehicle 10 is running toward the destination position, the result of the determination in step 110 is negative and the processing returns to step 104. Hence, the latest road condition information is acquired, remote driving segments are predicted in accordance with the latest road condition information, and the remote driving segments and autonomous driving segments are updated in step 108.

The road condition information includes information representing road conditions relating to running in the autonomous driving mode. Thus, the road condition information includes information relating to running of emergency vehicles and the like that may affect running in the autonomous driving mode.

For example, if at least a portion of a running path of an emergency vehicle or the like overlaps with the running path of the vehicle 10 and a predicted timing of passage of the vehicle 10 overlaps with a predicted timing of passage of the emergency vehicle or the like, then running information of the emergency vehicle or the like is included in the road condition information, and a segment of the running path of the vehicle 10 that is predicted to overlap with the running path of the emergency vehicle or the like is predicted to be a remote driving segment. If the predicted segment has been included in an autonomous driving segment, the predicted segment is changed to a remote driving segment in step 108.

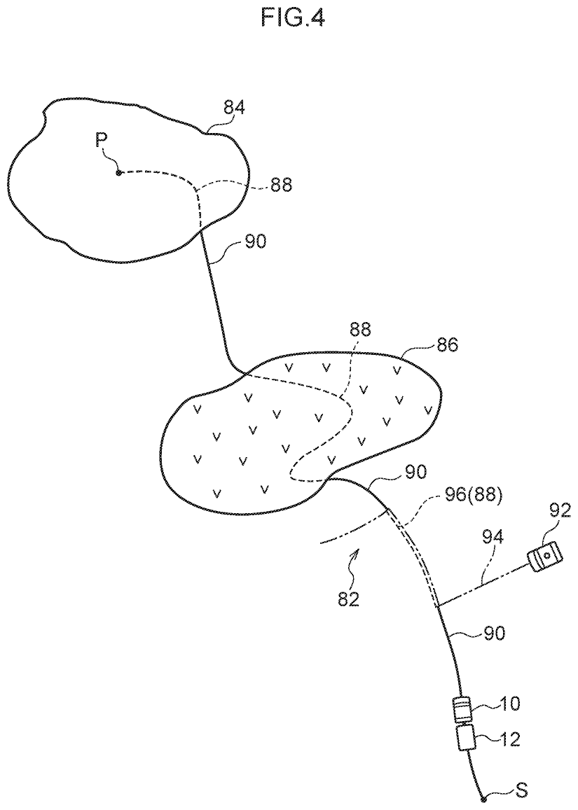

Thus, as an example, a running path 82 illustrated in FIG. 4 is specified. The running path 82 consists of segments from a running start position S of the vehicle 10 to a destination position P in a site of a leisure facility 84. The running path 82 may include a pasture (grazing area) 86 in which running of the vehicle 10 while towing the trailer 12 is possible but running in the autonomous driving mode is predicted to be difficult, and so forth.

In this running path 82, a segment from an entrance of the leisure facility 84 to the destination position P, a segment in the pasture 86 and the like are specified as remote driving segments 88, and other segments are specified as autonomous driving segments 90.

If there is a segment 96 in which a portion of a running path 94 of an emergency vehicle 92 is predicted to overlap with one of the autonomous driving segments 90 during the running of the vehicle 10, this segment 96 is specified as an additional remote driving segment 88.

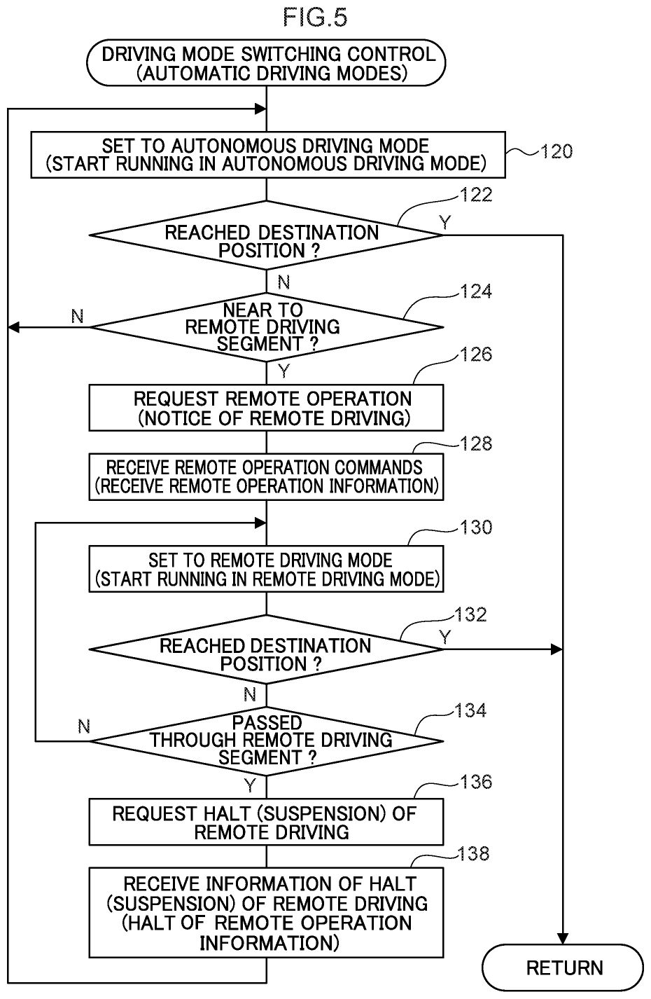

The running control device 30 conducts switching of the automatic driving modes between the autonomous driving mode and the remote driving mode. FIG. 5 shows driving mode switching processing that is executed by the running control device 30 (the ECU 32).

The driving mode switching processing in FIG. 5 starts execution when running of the vehicle 10 starts or the like, sets the autonomous driving mode in the first step 120, and starts running control of the vehicle 10 along the running path in the automatic driving modes. When the position of the vehicle 10 is in a remote driving segment, the running control device 30 switches from the autonomous driving mode to the remote driving mode and starts running control of the vehicle 10 in the remote driving mode (see step 130 below).

In step 122, the running control device 30 verifies whether or not the vehicle 10 has reached the destination position. When the vehicle 10 reaches the destination position or the like and running of the vehicle 10 ends, the result of the determination in step 122 is affirmative and the processing ends.

In step 124, the running control device 30 verifies whether or not the vehicle 10 is approaching a remote driving segment. If the vehicle 10 is not approaching a remote driving segment, the result of the determination in step 124 is negative, the running control device 30 proceeds to step 120, and running control of the vehicle 10 continues in the autonomous driving mode.

On the other hand, if the vehicle 10 is approaching a remote driving segment, the result of the determination in step 124 is affirmative and the running control device 30 proceeds to step 126. The determination in step 124 as to whether the vehicle 10 is approaching a remote driving segment may employ, for example, a determination as to whether a distance from the position of the vehicle 10 to a starting position of a remote driving segment has reached a pre-specified distance, a determination as to whether a predicted duration until the vehicle 10 reaches a remote driving segment is within a pre-specified duration, or the like.

In step 126, the running control device 30 makes a request to the remote operation terminal 60 for remote driving. When remote driving is requested, the remote operation terminal 60 prompts the remote operation staff to prepare for remote driving of the vehicle 10. In response, for example, the remote operation staff completes preparations for operation (preparation for entry of information into the remote operation device 66) and starts remote operation. Hence, the remote operation terminal control section 68 transmits remote driving commands and remote operation information.

When the running control device 30 receives remote operation information (or remote driving commands and remote operation information) from the remote operation terminal 60 in step 128, then in step 130 the running control device 30 sets the remote driving mode and starts running control of the vehicle 10 in accordance with the remote operation information. Thus, control may be smoothly handed over to the remote operation staff before the vehicle 10 reaches the remote driving segment.

Subsequently, in step 132, the running control device 30 checks whether or not the vehicle 10 has reached the destination position. If the vehicle 10 has reached the destination position, the result of the determination in step 132 is affirmative and the processing ends. If the vehicle 10 has not reached the destination position, the result of the determination in step 132 is negative and the running control device 30 proceeds to step 134. In step 134, the running control device 30 verifies whether or not the vehicle 10 has passed through the remote driving segment.

If the vehicle 10 has not passed through the remote driving segment, the result of the determination in step 134 is negative and the remote driving mode continues. If the vehicle 10 has passed through the remote driving segment, the result of the determination in step 134 is affirmative and the running control device 30 proceeds to step 136.

In step 136, the running control device 30 transmits information requesting a halt (suspension) of remote operation at the remote operation terminal 60 to the remote operation terminal 60. When the remote operation terminal control section 68 of the remote operation terminal 60 receives the information of the request to halt remote operation from the running control device 30, the remote operation terminal control section 68 reports this remote halt request to the remote operation staff. Accordingly, the remote operation staff stops entry of remote operations or enters information commanding a halt (suspension) of remote operation. Then the remote operation terminal control section 68 transmits information of the halt of remote operation to the running control device 30.

When the vehicle control section 48 of the running control device 30 receives the information commanding the halt of remote operation in step 138 (or transmissions of the remote operation information are halted and the vehicle control section 48 is no longer receiving the remote operation information), the running control device 30 proceeds to step 120 and switches to the autonomous driving mode. As a result, running control of the vehicle 10 in the autonomous driving mode begins. Thus, a smooth handover of control to the running control device 30 is possible.

In running control in the automatic driving modes that are not dependent on a vehicle occupant, the running control device 30 switches between the autonomous driving mode and the remote driving mode. Therefore, the vehicle 10 may run smoothly even when a running path of the vehicle 10 includes a segment in which running in the autonomous driving mode is difficult.

When remote operation information is entered, the running control device 30 switches from the autonomous driving mode to the remote driving mode. Here, the running control device 30 makes a request for remote operation to the remote operation terminal 60 when the vehicle 10 is approaching a remote driving segment that is predicted on the basis of the running path and the road condition information of the running path.

Therefore, because the remote operation staff may prepare for remote operation before the vehicle 10 reaches the remote driving segment, the driving mode may be smoothly switched from the autonomous driving mode to the remote driving mode, and the vehicle 10 may run smoothly. Moreover, because the vehicle 10 may be switched to the remote driving mode before entering the remote driving segment, a case of a switch to the remote driving mode being delayed—and consequently appropriate running control being delayed, the autonomous driving mode continuing, and running of the vehicle 10 becoming unreliable—may be prevented.

In the running control device 30, because remote operation is requested before a remote driving segment is reached, a need for remote operation staff to continuously wait in a state of being ready for remote operation may be eliminated, and burdens caused by the remote operation staff being continuously on standby in the state of being ready for remote operation may be moderated.

Conversely, when the vehicle 10 has passed through a remote driving segment predicted on the basis of the running path and the road condition information of the running path, the running control device 30 makes a request to the remote operation terminal 60 to halt remote operation. Therefore, the remote operation staff does not perform remote operation of the vehicle 10 for longer than necessary, and burdens on the remote operation staff in performing remote operation of the vehicle 10 may be moderated. Moreover, because remote operation segments in which the vehicle 10 is remotely operated by the remote operation staff are predicted in advance, a single remote operation staff member may conduct remote operations for a plural number of the vehicle 10, and the remote operation staff may continue remote operation when remote operation of the vehicle 10 should be continued.

The running control device 30 switches from the remote driving mode to the autonomous driving mode in response to a halt command from the remote operation terminal 60 or a halt of remote operation information. However, after a remote driving segment has ended, the running control device 30 may report a halt of the remote operation mode to the remote operation terminal 60 and switch from the remote driving mode to the autonomous driving mode. Accordingly, durations of running of the vehicle 10 in the remote driving mode may be made shorter and, for example, if fees are charged in accordance with durations of running of the vehicle 10 in the remote driving mode, costs may be kept down.

In the running control device 30, the remote driving segments are updated during running of the vehicle 10. When the running path and timings of running on the running path of the vehicle 10 overlap with a running path and running timings of an emergency vehicle, the running control device 30 switches from the autonomous driving mode to the remote operation mode.

Therefore, even if an emergency vehicle or the like running near to the running path of the vehicle 10 is encountered, the vehicle 10 may be prevented from affecting running of the emergency vehicle, and both the vehicle 10 and the emergency vehicle may achieve smooth running. For example, when an emergency vehicle passes through an intersection or the like, entry of the vehicle 10 into the intersection is restricted even if the vehicle 10 has a green light. Because the vehicle 10 is in the remote driving mode, the vehicle 10 may respond appropriately, and a case of the vehicle 10 impeding running of the emergency vehicle may be suppressed.

Because the running control device 30 updates the remote driving segments during running of the vehicle 10, even if a road obstruction such as a traffic restriction, an accident, roadworks or the like arises in the running path of the vehicle 10, the vehicle 10 may be put in the remote driving mode, enabling a suitable response by the remote operation staff. Thus, smooth running of the vehicle 10 to suit road conditions may be realized.

When a destination (destination position) of the vehicle 10 is in a site in which running in the autonomous driving mode is difficult, the running control device 30 switches from the autonomous driving mode to the remote driving mode. Thus, the vehicle 10 may reliably run the trailer 12 to the destination position.

In this case, because the running control device 30 may be switched into the remote driving mode before the vehicle 10 reaches the site of the destination (the remote driving segment), the vehicle 10 may progress into the destination site smoothly. That is, if the driving mode were switched to the remote driving mode after reaching the destination site, the remote operation staff would have to search for an entrance into the site while conducting remote operation of the vehicle 10, and wasteful use of time and running distance might occur. In contrast, because the driving mode is switched to the remote driving mode in advance, the vehicle 10 may be run up to the entrance of the site, and wasteful use of time and running distance may be suppressed. Moreover, if a procedure for receiving a permit at the entrance or the like is required for the vehicle 10 to progress to the destination position, this procedure and the like may be conducted smoothly when the vehicle 10 is in the remote driving mode.

The vehicle control system 20 according to the present exemplary embodiment may be employed in, for example, a management system that manages the trailer 12 as a rental item (a rental system).

The management system takes bookings for use from users for each type of the trailer 12. This management system receives usage information from a user, such as the type of the trailer 12, a dispatch location that is to be a usage position, a usage start time (a date and time the trailer 12 is to be delivered to the dispatch location), a usage end time (a date and time the trailer 12 is to be collected from the dispatch location), and so forth.

In the management system, a transport schedule for delivering and collecting the trailer 12 is specified on the basis of the usage information. The transport schedule includes, as well as the delivery date and time and the collection date and time, specification of a running path of the trailer 12, which is to be the running path of the vehicle 10 towing the trailer 12. A running path for the vehicle 10 to deliver one of the trailer 12 and then collect another trailer 12 from another collection position may be specified.

The vehicle control system 20 causes the vehicle 10 to run along the specified running path. Thus, the management system may respond appropriately to the wishes of users of the trailers 12. Furthermore, the management system may appropriately manage usage conditions of each trailer 12 and may charge suitable fees in accordance with the usage conditions of the trailers 12.

When the vehicle 10 is to run while towing the trailer 12 or in order to tow the trailer 12, the running control device 30 predicts the remote driving segments and specifies the remote driving segments and the autonomous driving segments. Hence, because the management system specifies the remote driving segments for each vehicle 10 in advance, if timings of running through remote driving segments do not overlap between two or more of a plural number of the vehicle 10, these vehicles 10 may be operated by a single remote operation staff member. Therefore, the trailers 12 may be smoothly delivered even while burdens on the remote operation staff may be moderated.

In the present exemplary embodiment described above, an example is described in which the trailer 12 runs by being linked to the vehicle 10 and towed by the vehicle 10. However, it is sufficient that a trailing vehicle is a vehicle that may run while being trailed by the vehicle 10. A trailing vehicle is not limited to configurations that are not provided with a drive source and that are towed via a towing apparatus. A trailing vehicle may be of a self-propelled type that is provided with a drive source for running and that may be driven to run and follow a vehicle by the drive source.

In the present exemplary embodiment, the navigation section 38 is provided separately from the ECU 32, but the navigation section 38 may be realized by a CPU of the ECU 32 executing a predetermined program. In the present exemplary embodiment, the navigation section 38 that corresponds to the prediction section is provided at the running control device 30, but the prediction section may be provided at the remote operation terminal 60 and may be provided at the server 70.

An object of the present disclosure is to provide a vehicle running control device that may enable smoother vehicle running of a vehicle whose running can be controlled in an autonomous driving mode and a remote driving mode.

A first aspect is a vehicle running control device that includes: a running control section that is capable of controlling running of a vehicle in an autonomous driving mode and in a remote driving mode and that controls running of the vehicle toward a destination, the autonomous driving mode controlling running of the vehicle on the basis of operation information relating to autonomous driving of the vehicle that is obtained from a running environment surrounding the vehicle, and the remote driving mode being based on operation information relating to remote driving of the vehicle that is entered through remote operation equipment operated by remote operation staff; a path information acquisition section that acquires a running path of the vehicle to the destination and path information relating to autonomous driving of the vehicle on the running path; a prediction section that, on the basis of the path information relating to autonomous driving, predicts a remote driving segment of the running path in which running control of the vehicle in the remote driving mode is required; a request section that, before the vehicle reaches the predicted remote driving segment, makes a request to the remote operation equipment for entry of the operation information relating to remote driving; and a switching section that, when the running control section is operating in the autonomous driving mode and the operation information relating to remote driving is entered through the remote operation equipment, switches the running control section to operate in the remote driving mode.

In the first aspect, running control of the vehicle is conducted in the autonomous driving mode, which conducts running control of the vehicle on the basis of operation information relating to autonomous driving of the vehicle that is obtained from the running environment surrounding the vehicle, and in the remote driving mode, which is based on operation information relating to remote driving of the vehicle that is entered by the remote operation staff. When entry of operation information relating to remote driving is requested and the operation information relating to remote driving is entered, the vehicle running control device switches so as to operate in the remote driving mode.

A running path to a destination of the vehicle is acquired, and path information relating to autonomous driving of the vehicle on the running path is acquired. On the basis of the running path and the path information relating to autonomous driving, remote driving segments of the running path, in which running control of the vehicle in the remote driving mode will be required, are predicted. Before the vehicle reaches a predicted remote driving segment, the vehicle running control device makes a request for entry of operation information relating to remote driving.

Thus, when a switch from the autonomous driving mode to the remote driving mode is required, operation information relating to remote driving is requested. Therefore, the switch from the autonomous driving mode to the remote driving mode may be made smoothly, and vehicle running may be made smoother. Moreover, because there is no need for the remote operation staff to continuously wait in a state of being ready for remote operation, burdens on the remote operation staff may be moderated.

A second aspect is the vehicle running control device of the first aspect, wherein, after the vehicle has passed through the remote driving segment, the request section makes a request to the remote operation equipment to halt the operation information relating to remote driving.

In the second aspect, when the vehicle has passed through a remote driving segment, a request is made for a halt of operation information relating to remote driving, that is, for a halt to remote operation by the remote operation staff. Thus, the remote driving mode may be ended and switched to the autonomous driving mode at a suitable time. Therefore, cases of remote driving lasting for longer than necessary may be suppressed and burdens on the remote operation staff may be moderated.

A third aspect is the vehicle running control device of the first or second aspect, wherein, when entry of the operation information relating to remote driving through the remote operation equipment is halted, the switching section causes the running control section to operate in the autonomous driving mode

In the third aspect, when the entry of operation information relating to remote driving has halted, the vehicle running control device switches from the remote driving mode to the autonomous driving mode. Thus, the remote operation staff may be released from remote operation, and burdens on the remote operation staff may be moderated.

A fourth aspect is the vehicle running control device of any of the first to the third aspect, wherein the path information includes information relating to another vehicle whose running path overlaps with the running path of the vehicle and information relating to running of the another vehicle.

In the fourth aspect, the path information includes running information relating to another vehicle with an overlapping running path. For example, a segment in which the running path of an emergency vehicle or the like overlaps with the running path of the present vehicle and a running timing of the present vehicle is predicted to overlap with a running timing of the emergency vehicle or the like is set as a remote driving segment. Thus, an effect of the present vehicle on running of the emergency vehicle or the like may be suppressed.

A fifth aspect is the vehicle running control device of any of the first to fourth aspect, wherein: the vehicle is capable of running while trailing a trailing vehicle, and the path information acquisition section sets a destination position relating to the trailing vehicle as the destination and acquires the running path and the path information relating to autonomous driving.

In the fifth aspect, even when the vehicle is running while trailing a trailing vehicle or the remote driving segments include a segment of running in order to trail the trailing vehicle, the trailing vehicle may be trailed and run appropriately.

A sixth aspect is the vehicle running control device of the fifth aspect, wherein the destination position is a trailing start position or trailing end position of the trailing vehicle that is in an area in which running control of the vehicle in the remote driving mode is required.

In the sixth aspect, a destination position of the vehicle is a trailing start position or trailing end position of a trailing vehicle. Accordingly, the trailing vehicle may be trailed appropriately even when the trailing start position or trailing end position of the trailing vehicle is in a segment in which running in the autonomous driving mode is difficult. The vehicle running control device of the first to the sixth aspect can be realized in the form of a vehicle running control method.

According to the present disclosure, in a vehicle that is capable of running in an autonomous driving mode and a remote driving mode, switching into the remote driving mode may be conducted smoothly and driving control may be made more efficient. Furthermore, the present disclosure may moderate burdens on remote operation staff

1. A vehicle running control device comprising:
a memory; and
a processor connected to the memory, the processor being configured to:
be capable of controlling running of a vehicle in an autonomous driving mode and in a remote driving mode and control running of the vehicle toward a destination, the autonomous driving mode controlling running of the vehicle on the basis of operation information relating to autonomous driving of the vehicle that is obtained from a running environment surrounding the vehicle, and the remote driving mode being based on operation information relating to remote driving of the vehicle that is entered through remote operation equipment operated by remote operation staff;
acquire a running path of the vehicle to the destination and path information relating to autonomous driving of the vehicle on the running path;
on the basis of the path information relating to autonomous driving, predict a remote driving segment of the running path in which running control of the vehicle in the remote driving mode is required;
before the vehicle reaches the predicted remote driving segment, make a request to the remote operation equipment for entry of the operation information relating to remote driving; and
when running is being controlled in the autonomous driving mode and the operation information relating to remote driving is entered through the remote operation equipment, switch to operate in the remote driving mode.

2. The vehicle running control device according to claim 1 wherein the processor is configured to, after the vehicle has passed through the remote driving segment, make a request to the remote operation equipment to halt the operation information relating to remote driving.

3. The vehicle running control device according to claim 1, wherein the processor is configured to, when entry of the operation information relating to remote driving through the remote operation equipment is halted, operate in the autonomous driving mode.

4. The vehicle running control device according to claim 1, wherein the path information includes information relating to another vehicle whose running path overlaps with the running path of the vehicle and information relating to running of the another vehicle.

5. The vehicle running control device according to claim 1, wherein:
the vehicle is capable of running while trailing a trailing vehicle, and
the processor is configured to set a destination position relating to the trailing vehicle as the destination and acquire the running path and the path information relating to autonomous driving.

6. The vehicle running control device according to claim 5, wherein the destination position is a trailing start position or trailing end position of the trailing vehicle that is in an area in which running control of the vehicle in the remote driving mode is required.

7. A vehicle running control method comprising:
by a processor,
being able of controlling running of a vehicle in an autonomous driving mode and in a remote driving mode and control running of the vehicle toward a destination, the autonomous driving mode controlling running of the vehicle on the basis of operation information relating to autonomous driving of the vehicle that is obtained from a running environment surrounding the vehicle, and the remote driving mode being based on operation information relating to remote driving of the vehicle that is entered through remote operation equipment operated by remote operation staff;
acquiring running path of the vehicle to the destination and path information relating to autonomous driving of the vehicle on the running path;
on the basis of the path information relating to autonomous driving, predicting a remote driving segment of the running path in which running control of the vehicle in the remote driving mode is required;
before the vehicle reaches the predicted remote driving segment, making a request to the remote operation equipment for entry of the operation information relating to remote driving; and
when running is being controlled in the autonomous driving mode and the operation information relating to remote driving is entered through the remote operation equipment, switching to operate in the remote driving mode.

8. The vehicle running control method according to claim 7, wherein, after the vehicle has passed through the remote driving segment, a request is made to the remote operation equipment to halt the operation information relating to remote driving.

9. The vehicle running control method according to claim 7, wherein, when entry of the operation information relating to remote driving through the remote operation equipment is halted, running is being controlled in the autonomous driving mode.

10. The vehicle running control method according to claim 7, wherein the path information includes information relating to another vehicle whose running path overlaps with the running path of the vehicle and information relating to running of the another vehicle.

11. The vehicle running control method according to claim 7, wherein:
the vehicle is capable of running while trailing a trailing vehicle, and
a destination position relating to the trailing vehicle is set as the destination and the running path and the path information relating to autonomous driving is acquired.

12. The vehicle running control method according to claim 11, wherein the destination position is a trailing start position or trailing end position of the trailing vehicle that is in an area in which running control of the vehicle in the remote driving mode is required.
